(19) United States
(12) Patent Application Publication
(10) Pub. No.: US 2022/0236105 A1
(43) Pub. Date: Jul. 28, 2022

(54) DETECTION OF STATIC WEIGHT ON AERIAL TELECOMMUNICATIONS OPTICAL FIBERS USING DAS AMBIENT DATA

(71) Applicant: NEC Laboratories America, Inc., Princeton, NJ (US)

(72) Inventors: Sarper Ozharar, Princeton, NJ (US); Yue Tian, Princeton, NJ (US); Ting Wang, West Windsor, NJ (US); Yangmin Ding, North Brunswick, NJ (US)

(73) Assignee: NEC LABORATORIES AMERICA, INC, Princeton, NJ (US)

(21) Appl. No.: 17/583,168

(22) Filed: Jan. 24, 2022

Related U.S. Application Data
(60) Provisional application No. 63/140,981, filed on Jan. 25, 2021.

(51) Int. Cl. G01H 9/00; G01D 5/353

(52) U.S. Cl. CPC G01H 9/004; H04B 10/071; G01D 5/353

(57) ABSTRACT

An advance in the art is made according to aspects of the present disclosure directed to the detection and localization of a substantially static weight situated on aerial telecommunications fiber optic cable through the effect of phase-distributed acoustic sensing (ϕ-DAS) and signal analysis of ambient data. In sharp contrast to the prior art, our inventive method does not require a special optical fiber arrangement or type of fiber nor is it susceptible to range limitations that plague the prior art.

### CROSS REFERENCE TO RELATED APPLICATIONS

This application claims the benefit of U.S. Provisional Patent Application Ser. No. 63/140,981 filed 25 Jan. 2021 the entire contents of which is incorporated by reference as if set forth at length herein.

### TECHNICAL FIELD

This disclosure relates generally to distributed fiber optic sensing (DFOS). More particularly, it pertains to the detection/localization of static weight on aerial telecommunications optical fibers/cables using distributed acoustic sensing (DAS) ambient data.

### BACKGROUND

As will be understood by those skilled in the art—and due in part to economic and practical reasons—a substantial portion of fiber optic networks include aerial fiber optic cables suspended from utility poles. Such aerial fiber optic cables—unlike underground cables—are quite susceptible to environmental conditions including extreme weather, geological activity, traffic, animal activities, and trees. One critical consideration that threatens aerial fiber optic cables is additional weight placed on the aerial cables from—for example—ice buildup, tree branches, improper installation, etc. Unfortunately, such additional weight(s) may not produce sufficient vibrations or other conditions detectable by conventional distributed fiber optic sensing (DFOS) techniques.

### SUMMARY

An advance in the art is made according to aspects of the present disclosure directed to the detection and localization of a substantially static weight situated on aerial telecommunications fiber optic cable through the effect of phase-distributed acoustic sensing (ϕ-DAS) and signal analysis of ambient data.

In sharp contrast to the prior art, our inventive method does not require a special optical fiber arrangement or type of fiber nor is it susceptible to range limitations that plague the prior art.

Viewed from an operational aspect, our inventive method detects a static weight on aerial telecommunications optical fiber using a distributed fiber optic sensing (DFOS)/φ-Distributed Acoustic Sensing (φ-DAS) system by providing the φ-DAS system including a φ-DAS interrogator/analyzer in optical communication with the aerial telecommunications optical fiber, the aerial telecommunications optical fiber is suspended from a plurality of utility poles; operating the φ-DAS system to obtain ambient baseline data and determine by Frequency Domain Decomposition (FDD) and singular value decomposition (SVD) a baseline natural frequency of the aerial telecommunications optical fiber; operating the φ-DAS system to obtain current data and determine by Frequency Domain Decomposition (FDD) and singular value decomposition (SVD) a current natural frequency of the aerial telecommunications optical fiber; determining, if additional weight is affecting the aerial telecommunications optical fiber from the baseline natural frequency and the current natural frequency; and reporting, based on the determination of additional weight, that additional weight is affecting the aerial telecommunications optical fiber to service personnel.

### BRIEF DESCRIPTION OF THE DRAWING

A more complete understanding of the present disclosure may be realized by reference to the accompanying drawing in which:

FIG. 1 is a schematic diagram of an illustrative DFOS arrangement as is known in the art;

FIG. 2 is a schematic diagram of an illustrative aerial fiber optic cable arrangement and ϕ-DAS, in which a static weight is suspended from the aerial cable according to aspects of the present disclosure;

FIG. 3(A) and FIG. 3(B) are waterfall plots/images of the aerial fiber optic cable under ambient excitations in which: FIG. 3(A) without additional static weight; and FIG. 3(B) with 20 lbs. between two poles according to aspects of the present disclosure;

FIG. 4(A) and FIG. 4(B) are singular value decomposition (SVD) plots of the fiber segment between poles where the static weight is located in the frequency range of: FIG. 4(A) 0 Hz-1000 Hz; and FIG. 4(B) 0 Hz-80 Hz, according to aspects of the present disclosure;

FIG. 5(A) and FIG. 5(B) are SVD plots of the fiber segment between poles where the static weight is not located showing no shift in SVD values in the frequency range of: FIG. 4(A) 0 Hz-1000 Hz; and FIG. 4(B) 0 Hz-80 Hz, according to aspects of the present disclosure; and

FIG. 6 is a schematic flow chart diagram of an illustrative DFOS/p-DAS operation according to aspects of the present disclosure.

The illustrative embodiments are described more fully by the Figures and detailed description. Embodiments according to this disclosure may, however, be embodied in various forms and are not limited to specific or illustrative embodiments described in the drawing and detailed description.

### DESCRIPTION

The following merely illustrates the principles of the disclosure. It will thus be appreciated that those skilled in the art will be able to devise various arrangements which, although not explicitly described or shown herein, embody the principles of the disclosure and are included within its spirit and scope.

Furthermore, all examples and conditional language recited herein are intended to be only for pedagogical purposes to aid the reader in understanding the principles of the disclosure and the concepts contributed by the inventor(s) to furthering the art and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that any block diagrams herein represent conceptual views of illustrative circuitry embodying the principles of the disclosure.

Unless otherwise explicitly specified herein, the FIGs comprising the drawing are not drawn to scale.

By way of some additional background—we again note that in recent years, distributed fiber optic sensing (DFOS) systems including distributed vibration sensing (DVS) and distributed acoustic sensing (DAS) have found widespread acceptance in numerous applications including—but not limited to—infrastructure monitoring, intrusion detection, and earthquake detection. For DAS and DVS, backward Rayleigh scattering effects are used to detect changes in the fiber strain, while the fiber itself acts as the transmission medium for conveying the optical sensing signal back to an interrogator for subsequent analysis.

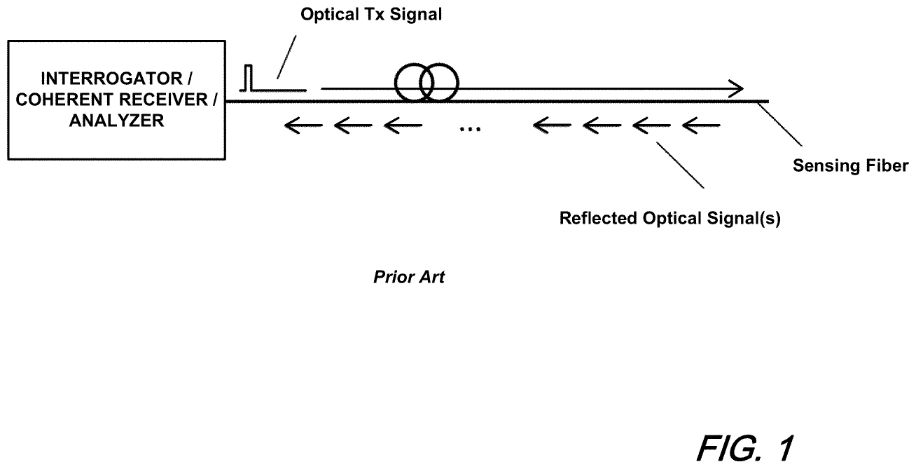

With reference to FIG. 1 which is a schematic diagram of an illustrative distributed fiber optic sensing system generally known in the art—we note that distributed fiber optic sensing (DFOS) has become an important and widely used technology to detect environmental conditions (such as temperature, vibration, stretch level etc.) anywhere along an optical fiber cable that in turn is connected to an interrogator. As is known, contemporary interrogators are systems that generate an input signal to the fiber and detects/analyzes the reflected/scattered and subsequently received signal(s). The signals are analyzed, and an output is generated which is indicative of the environmental conditions encountered along the length of the fiber. The signal(s) so received may result from reflections in the fiber, such as Raman backscattering, Rayleigh backscattering, and Brillion backscattering. It can also be a signal of forward direction that uses the speed difference of multiple modes. Without losing generality, the following description assumes reflected signal though the same approaches can be applied to forwarded signal as well.

As will be appreciated, a contemporary DFOS system includes the interrogator that periodically generates optical pulses (or any coded signal) and injects them into an optical fiber. The injected optical pulse signal is conveyed along the optical fiber.

At locations along the length of the fiber, a small portion of signal is reflected and conveyed back to the interrogator. The reflected signal carries information the interrogator uses to detect, such as a power level change that indicates—for example—a mechanical vibration.

The reflected signal is converted to electrical domain and processed inside the interrogator. Based on the pulse injection time and the time signal is detected, the interrogator determines at which location along the fiber the signal is coming from, thus able to sense the activity of each location along the fiber.

As those skilled in the art will understand and appreciate, phase-sensitive coherent optical time-domain reflectometry (ϕ-OTDR) is a technique that can provide sufficient sensitivity and resolution for distributed acoustic sensing (DAS) systems. As is known, standard optical time-domain reflectometry techniques use light sources with coherence lengths that are shorter than pulse lengths. This can yield a sum of backscattered intensities from each scattering center, which allows monitoring splices and breaks in fiber optic cables. On the contrary, in ϕ-OTDR-based sensors, the coherence length of laser light sources is longer than their pulse length. An event near the fiber generates an acoustic wave that affects the optical fiber by changing the phases of the backscattering centers. An analysis of such signals reveals their impact on the sensor fiber and therefore monitor environmental events located near sensor fibers.

As we previously noted, additional weight placed on aerial optical fibers are a risk both to people and the network operation. Therefore, such additional weight must be detected and properly remedied before accidents and/or network outages. Unfortunately, such additional static weight on a fiber cable do not create a temporally varying vibration and therefore cannot be detected directly by standard distributed fiber optic sensor—distributed acoustic sensor systems.

While methods for detection of a static weight on a fiber cable have been previously reported they exhibit limited range and require a special fiber arrangement or a fiber type such as a fiber Bragg grating. In sharp contrast our inventive method according to aspects of the present disclosure detects and localizes a static weight on a standard aerial communication fiber cable using φ-DAS (phase-Distributed Acoustic Sensing) signal analysis of recorded ambient data.

Experimental Setup

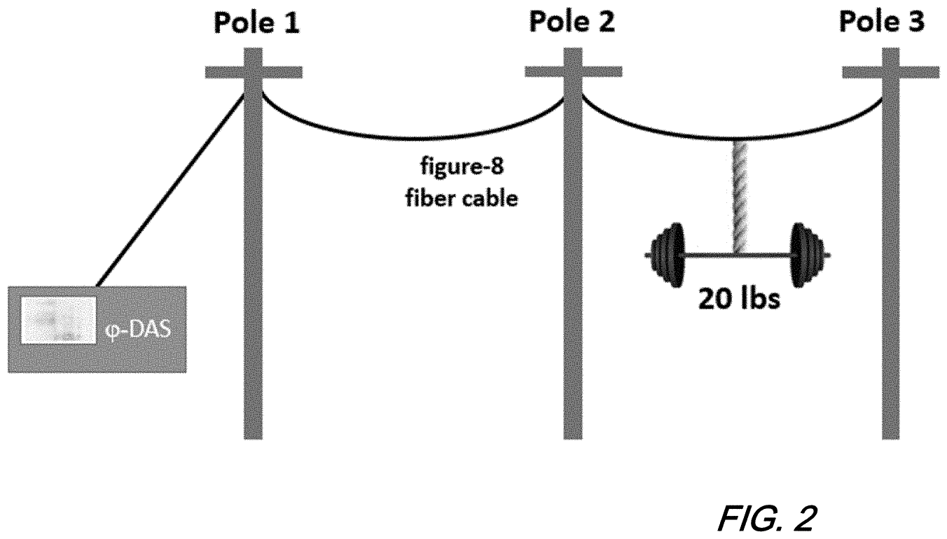

To demonstrate our inventive method, an illustrative, real-scale testbed comprising of 3 wooden utility poles (Pole 1, Pole 2, and Pole 3) connected by dummy power cables and several common, contemporary, outdoor-grade aerial fiber cables was constructed. FIG. 2 is a schematic diagram of the illustrative aerial fiber optic cable testbed arrangement and ϕ-DAS, in which a static weight is suspended from the aerial cable according to aspects of the present disclosure.

The utility poles in the testbed are known in the art as Class 2 type and substantially 35 feet in length. They are spaced substantially 90 feet from each other in a linear manner. The DAS system was located inside a control room approximately 350 meters away from the first pole in terms of fiber length. The aerial optical fiber cable installed at the poles is a 36-strand single-mode outdoor figure-8 cable with a 0.25-inch messenger.

Operationally, the optical pulse width for the DAS experimental/test bed setup was selected as 40 ns, and a pulse repetition rate of 3 kHz was used for data collection. The locations/distances of the three poles along the fiber cable are manually obtained by a hammer. That is, during an initial “learning” phase of DAS operation, the individual utility poles are struck with a hammer and the DAS data from those impacts are used to collect/determine data representative of a normal response of the DAS and the respective distance(s) of the individual utility poles from the interrogator. Such distances were determined—in the experimental testbed—to be 347 meters, 387 meters, and 427 meters, respectively.

As part of the weight detection determination, first the ambient data (i.e., the natural vibrations of the fiber cables without any external controlled excitations) of the aerial cables was recorded. Later, 20 lbs. of weight was hanged on the fiber cable between Pole 2 and Pole 3, and again the ambient data was recorded after the weight and cable settle into a static state (i.e., stopped moving). In both cases ambient data was recorded for 15 minutes.

Method

When the aerial fiber cable is monitored by an operating DAS system, there is no directly detectable difference between the scenario in which a weight is suspended and scenario in which there is no suspended weight. This is because the weight is static and does not create a dynamic strain change in the fiber, except for the moment the weight is physically hanged (or removed) from the fiber cable.

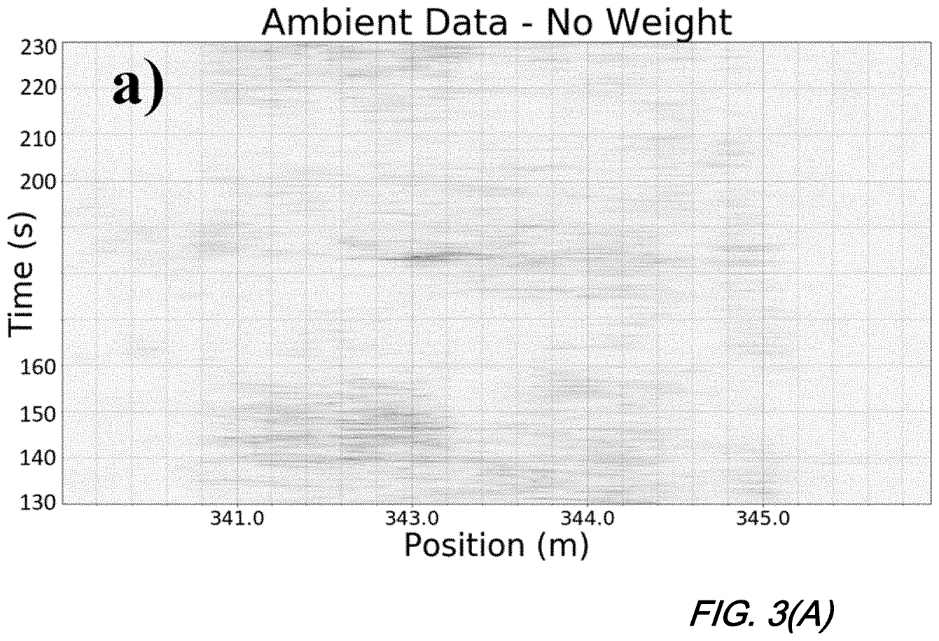

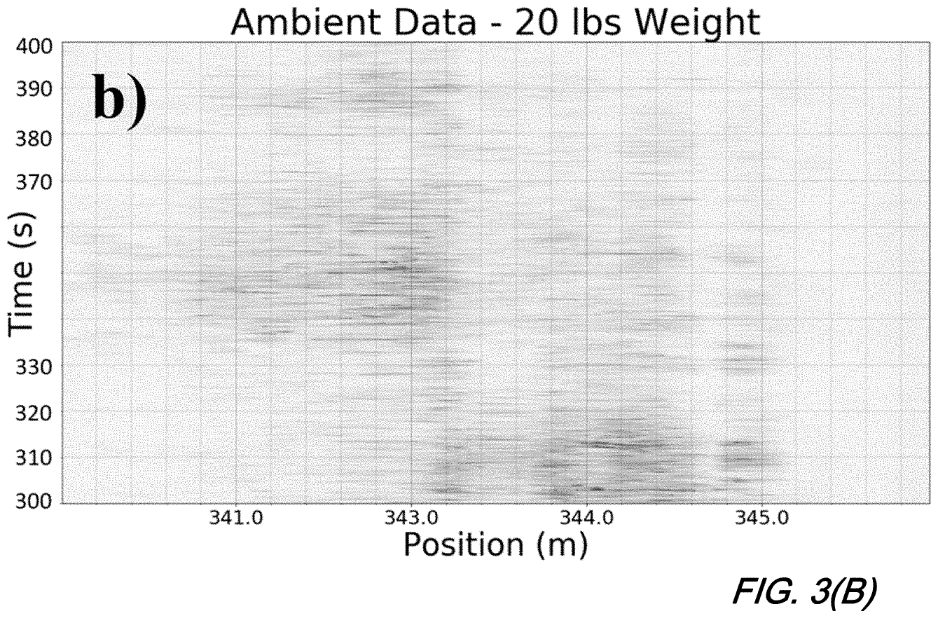

However, after that moment of hanging (or removal), it is difficult to tell directly from a DAS signal whether the additional weight has fallen off or is still attached to the fiber cable. FIG. 3(A) and FIG. 3(B) are waterfall plots/images of the aerial fiber optic cable under ambient excitations in which: FIG. 3(A) without additional static weight; and FIG. 3(B) with 20 lbs. between two poles according to aspects of the present disclosure. We note that the 20 lb. weight is hung between Pole 2 and Pole 3 (at approximately 400 meter) and the waterfall images in the figure illustrate the temporal change (y-axis) for a duration of 100 seconds in the DAS signal along the fiber range of 340 meters-440 meters.

As may be observed from the figure and as noted previously, a static weight cannot be detected nor localized by direct monitoring of the ambient DAS signal in the spatial-temporal domain. However, the additional weight suspended on the fiber optic cable changes the tension on the cable and its natural vibration frequency characteristics. As a result, a modal analysis technique—Frequency Domain Decomposition (FDD)—is utilized to detect the natural frequency change of the fiber cable due to the additional weight using only ambient data. As those skilled in the art will understand and appreciate, the frequency domain decomposition (FDD) technique is an output-only system identification technique frequently used in civil engineering—particularly structural health monitoring. As an output-only method, it is useful when input data is unknown. FDD is a modal analysis technique that generates a system realization using frequency response given (multi-)output data.

Operationally, a generic FDD proceeds as follows. First, estimate a cross spectral density matrix Ĝ_{yy}(jωᵢ) at discrete frequencies ω=ωᵢ. Second, do a singular value decomposition of the power spectral density, i.e., Ĝ_{yy}(jωᵢ)=UᵢSᵢUᵢ^{H} where Uᵢ=[uᵢ₁, uᵢ₂, . . . , uᵢₙ] is a unitary matrix holding the singular values uᵢⱼ, and Sᵢ is the diagonal matrix holding the singular values sᵢⱼ. For an n degree of freedom system then pick the n dominating peaks in the power spectral density using whichever technique is appropriate. These peaks correspond to the mode shapes. Using the mode shapes, an input-output realization is written.

In our method according to the present disclosure, each fiber segment between two poles is taken as a single structure and analyzed separately. The first segment is the fiber cable between Pole 1 and Pole 2, and the second segment is the fiber cable between Pole 2 and Pole 3, where—in our illustrative experimental trial—the 20 lbs. weight is placed or removed.

During our trial, ambient data along the entire fiber length was recorded for 15 minutes. In our trial DAS experimental setup—which exhibits a spatial resolution of 1.22 meters—the entire length of fiber cable can be considered as individual sensors along the length of fiber at every 1.22 meters. Equally spaced 12 sensor points along the fiber are chosen from each segment for FDD analysis, then the cross-spectral-density (CSD) matrix was calculated for each segment. In the next step, the singular value decomposition (SVD) method was applied to the CSD matrix and obtained the first singular values as a function of frequency. These calculations are completed for both segments (between Pole 1 and Pole 2, and between Pole 2 and Pole 3), and for both cases (without any additional weight, and with 20 lbs. additional weight hanging on segment 2, i.e., between Pole 2 and Pole 3).

Results and Discussion

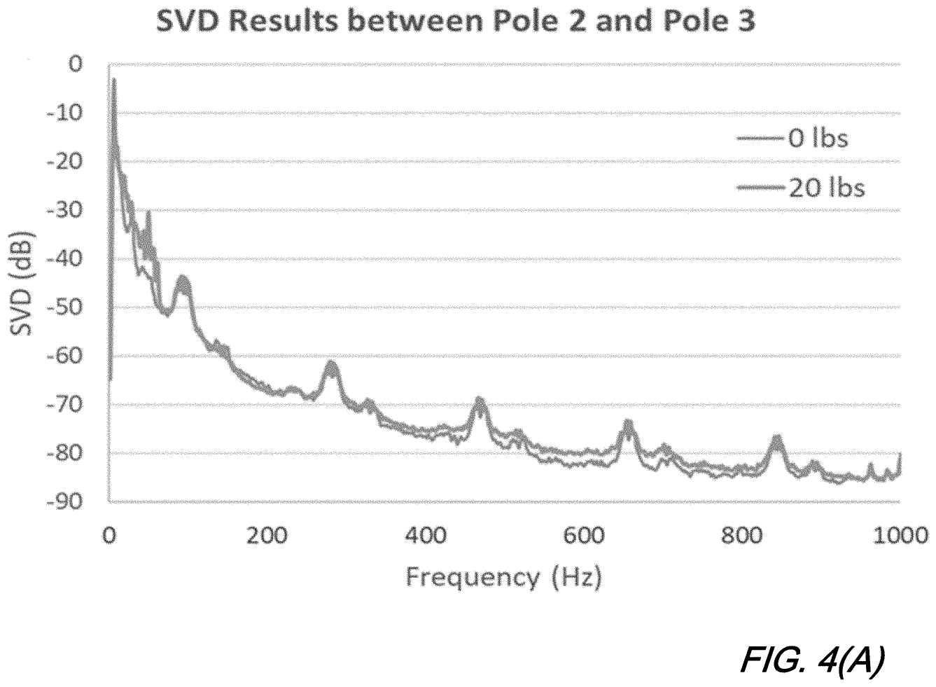

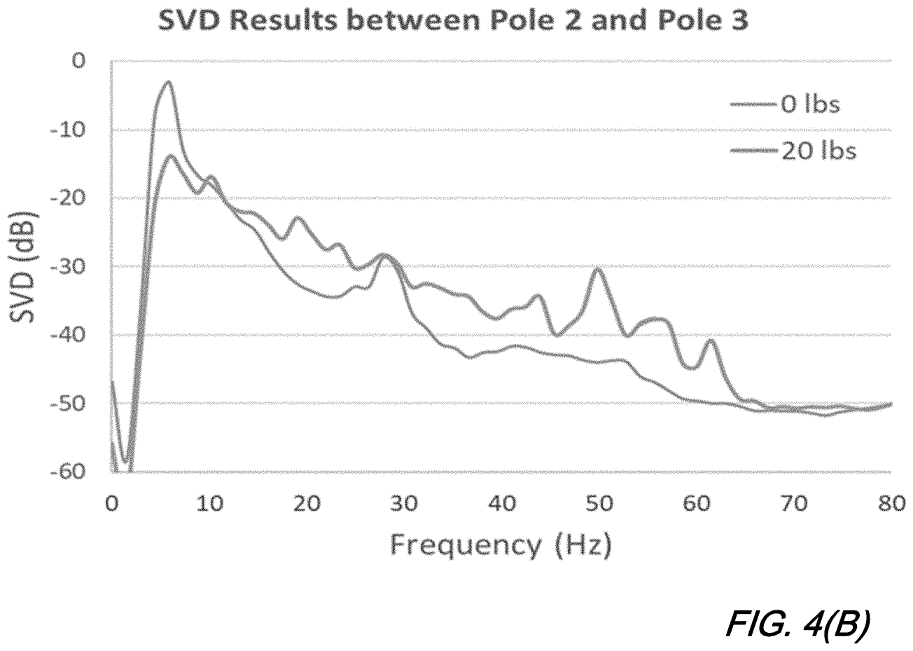

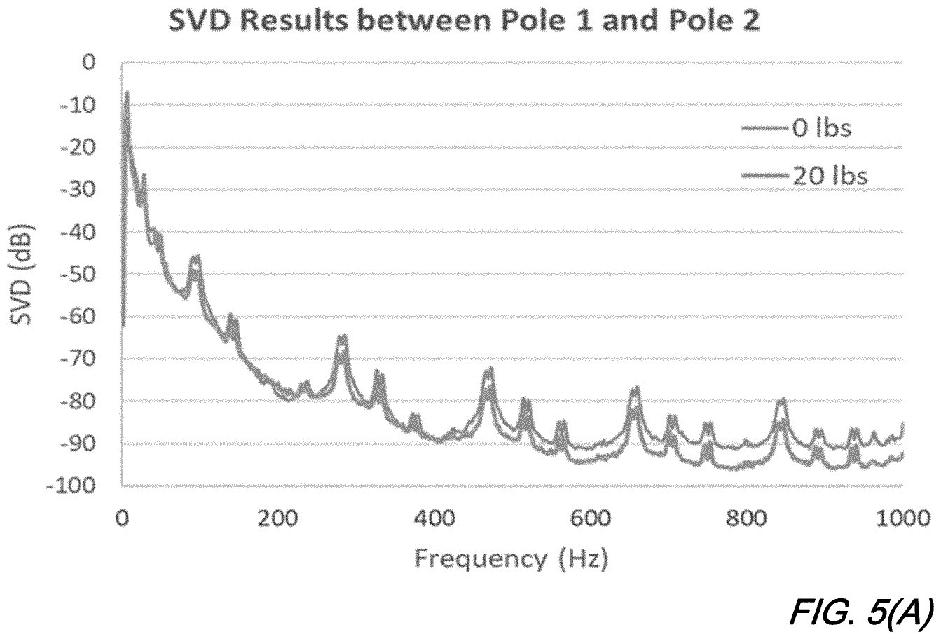

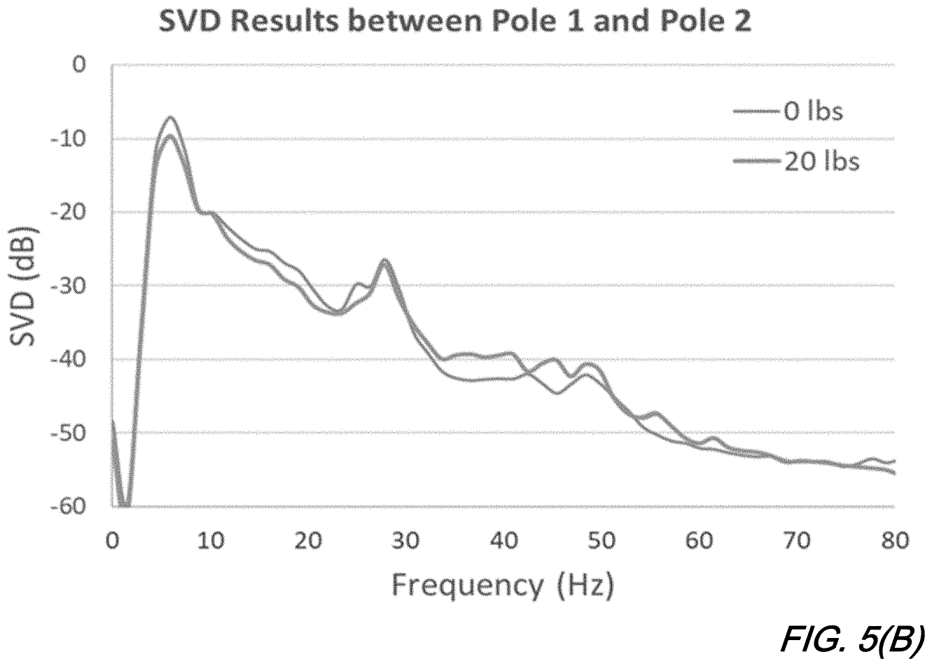

Using the FDD algorithm, explained in the previous section, the first singular values with and without the additional weight were calculated in the region between Pole 2 and Pole 3 (where the additional weight is placed). The resulting SVD graphs plotted in FIG. 4(A) and FIG. 4(B) which are singular value decomposition (SVD) plots of the fiber segment between poles where the static weight is located in the frequency range of: FIG. 4(A) 0 Hz-1000 Hz; and FIG. 4(B) 0 Hz-80 Hz, according to aspects of the present disclosure. They illustrate that the SVD peak shifts considerably to a higher frequency as expected. One of the strongest peaks of this region was around 29 Hz before the weight is placed, and a new strong peak at 49 Hz appears after the weight is hung on the fiber cable.

In order to further support our findings, we have also calculated the SVD values in the region between Pole 1 and Pole 2, with and without the additional weight between Pole 2 and Pole 3. As expected, we did not observe a change in the SVD graphs in this region as shown in FIG. 4, since no additional weight was applied in this region. This further supports that the SVD shift we have observed is due to the static weight placed on the aerial cable.

As a result, we have, for the first time to our knowledge, detected and localized a static weight on an aerial communication cable by using ambient data taken by a φ-DAS system. We used an FDD algorithm for modal analysis and observed an SVD peak shift from 29 Hz to 49 Hz in the segment where the static weight is placed, while the SVD peaks stay the same in another segment where there is no additional weight. We believe this ambient data-based analysis method is very promising for real-time monitoring and locating static weights along an aerial fiber optic network and minimizing the accident risks associated with the weights hanging on aerial cables.

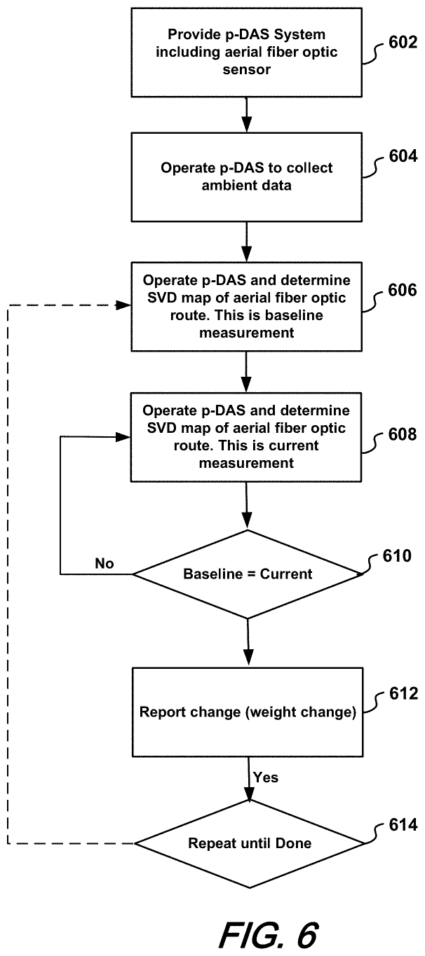

FIG. 6 is a schematic flow chart diagram of an illustrative DFOS/p-DAS operation according to aspects of the present disclosure. With reference to that figure, at block 602, a phase-distributed acoustic sensing system is provided including an aerial fiber optic sensor cable suspended by utility poles. As those skilled in the art will appreciate, such an arrangement will likely include a plurality of utility poles. As we shall later describe, individual sections of the aerial fiber optic sensor cable that are suspended between two poles of the plurality of poles, may advantageously be analyzed individually and therefore weight(s) suspended between particular poles may be determined.

At block 604, the p-DAS is operated to collect ambient data. At block 606, the p-DAS is operated and an FFD analysis is performed and an SVD map is determined for a desired fiber route exhibited by the fiber optic sensor cable. The SVD map so determined/generated is a baseline measurement.

At block 608, the p-DAS is operated and an FDD analysis is performed and an SVD map of the aerial fiber optic cable route is determined. This is the current measurement and the current measurement is compared with the baseline measurement at block 608. If the baseline is the same as the current, then the operation proceeds as necessary by repeating the blocks 608-610. If the baseline is not the same as the current, then a report of the detected change may be made and/or alarms generated such that technicians may be deployed to the location(s) of the aerial fiber optic cable where the change in weight was detected/determined. Note that when the overall fiber optic cable route is “segmented” into those portions/lengths of the fiber optic cable between utility poles, a particular segment of fiber may be identified as one to which the technician is deployed.

Finally, at block 614, after such a report/alarm is dispatched, the system may repeat the above processes either immediately, or at a later time subsequent to any repair/remediation that may have taken place on the aerial fiber optic cable.

At this point, while we have presented this disclosure using some specific examples, those skilled in the art will recognize that our teachings are not so limited. Accordingly, this disclosure should be only limited by the scope of the claims attached hereto.

1. A method for detecting a static weight on aerial telecommunications optical fiber using a distributed fiber optic sensing (DFOS)/φ-Distributed Acoustic Sensing (φ-DAS) system, the method comprising:
providing the φ-DAS system including a φ-DAS interrogator/analyzer in optical communication with the aerial telecommunications optical fiber, the aerial telecommunications optical fiber is suspended from a plurality of utility poles;
operating the φ-DAS system to obtain ambient baseline data and determine by Frequency Domain Decomposition (FDD) and singular value decomposition (SVD) a baseline natural frequency of the aerial telecommunications optical fiber;
operating the φ-DAS system to obtain current data and determine by Frequency Domain Decomposition (FDD) and singular value decomposition (SVD) a current natural frequency of the aerial telecommunications optical fiber;
determining, if additional weight is affecting the aerial telecommunications optical fiber from the baseline natural frequency and the current natural frequency; and
reporting, based on the determination of additional weight, that additional weight is affecting the aerial telecommunications optical fiber to service personnel.

2. The method of claim 1 wherein a baseline natural frequency is determined for each section of the aerial telecommunications optical fiber, wherein a section of the aerial telecommunications optical fiber is that length of the aerial telecommunications optical fiber which spans two adjacent utility poles of the plurality of utility poles.

3. The method of claim 1 wherein a current natural frequency is determined for each section of the aerial telecommunications optical fiber.

4. The method of claim 3 wherein the aerial telecommunications optical fiber comprises a plurality of sections and determinations are made from the baseline natural frequencies and current natural frequencies of one or more sections of the aerial telecommunications optical fiber additional weight affecting the one or more sections.

5. The method of claim 4 wherein, based on the determinations made from the baseline natural frequencies and current natural frequencies of the one or more sections of the aerial telecommunications optical fiber with respect to additional weight, reporting those sections experiencing additional weight as so determined.
